(19) United States
(12) Patent Application Publication
(10) Pub. No.: US 2009/0308265 A1
(43) Pub. Date: Dec. 17, 2009

(54) Food processing device

(75) Inventor: Heimo Obersteiner, Klagenfurt (AT)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/997,760

(22) PCT Filed: Jul. 25, 2006
(86) PCT No.: PCT/IB06/52540

§ 371 Date: Jul. 8, 2008

(30) Foreign Application Priority Data
Aug. 4, 2005 (EP) 05107199.1

(51) Int. Cl. A47J 43/00; B01F 7/28

(52) U.S. Cl. 99/537; 366/314

(57) ABSTRACT

To have the tool (410a,b) of a food processing device stop (1) within 1.5 seconds after removal of the lid (2), a food processing device (1) is proposed, the food processing device (1) comprising a container (2) comprising a central shaft (200) fixedly mounted on the container bottom (201), a lid (3) covering the container (2), and a processing tool unit (4) supporting a food processing tool (410a,b), its upper end (400) being couplable with a drive unit through the lid (3), its lower end (401) having an elongated cavity (402) for rotatably engaging with the central shaft (200) and allowing for pivotal movement about the axis (A) of the central shaft (200), wherein a bearing part (403) is provided inside the cavity (402), the bearing part (403) having a predetermined shape (405, 407, 408) on its inner surface for jamming with the central shaft (200) during the pivotal movement.

The present invention relates to a food processing device comprising a container comprising a central shaft fixedly mounted on the container bottom, a lid covering the container, and a processing tool unit supporting a food processing tool, its upper end being couplable with a drive unit through the lid, its lower end having an elongated cavity for rotatably engaging with the central shaft and allowing for pivotal movement about the axes of the central shaft. In particular, it relates to a food processing device working with high speed rotation, like for chopping.

Food processing devices are subjected to strict safety regulations, especially if they operate with dangerous tools like blades. Usually, the processing of food by e.g. kitchen appliances is based on a rotational movement of a tool. By rotating a blade or a set of blades, or a disk with a set of blades, food is chopped, cut, grated, mixed, blended etc. If the appliance is switched off, the tool continues to rotate with quite high speed due to inertia. Thus, the user could still injure himself.

Most food processing devices have a container with a lid, the tool operating inside the container, to avoid food splashing outside the container during processing. To get approval such devices have to fulfill inter alia the safety regulation IEC: 2002—60335-2-14/Part 20.112, according to which the cutting blade of a food processor shall stop within 1.5, seconds after the lid has been opened or removed—even without load and at the highest speed.

In WO 02/32278 A1 a kitchen appliance meeting this requirement has been described. The kitchen appliance has a container, a cover for the container, and a tool drive means, which is accommodated in the container and rotatably supported in the container with the aid of bearing means, which allow a pivotal movement about the vertical axis in case the cover is removed. In the center of its bottom wall the container has a bearing pin rotatably supporting the tool drive means. The tool driving means has a bearing means for cooperation with the bearing pin. The bearing means has a bearing cap, which changes into a flared central bearing rim. The bearing cap has a shape, which slightly widens toward the central bearing rim, as a result of which the bearing means is clear of the bearing pin, thus allowing the tool drive means to perform a limited pivotal movement about the bearing pin. The tool drive means is equipped with a brake ring made of rubber and facing the bottom wall of the container. During the pivotal movement the brake ring gets in contact with the bottom wall of the container and produces a very rapid and effective braking action at regular speed of a kitchen appliance, e.g. around 3000 rpm.

In case of appliances dedicated to specific kinds of processing such as chopping, much higher speeds are used, normally ca. 12000-15000 rpm, for higher efficiency. The centrifugal forces are so strong that the brake ring has no effect, and the tool drive means is ejected from the bearing pin. This is very dangerous for the user, as the tool drive means may even be ejected form the container when removing the cover. Besides, the tool drive means may damage the other parts of the appliance.

It is an object of the present invention to provide a food processing device decelerating very fast, when pivotal movement around the central shaft is allowed by e.g. removing the lid.

This object is achieved by a food processing device comprising a container comprising a central shaft fixedly mounted on the container bottom, a lid covering the container, and a processing tool unit supporting a food processing tool, its upper end being couplable with a drive unit through the lid, its lower end having an elongated cavity for rotatably engaging with the central shaft and allowing for pivotal movement about the axis of the central shaft, wherein a bearing part is provided inside the cavity, the bearing part having a predetermined shape on its inner surface for jamming with the central shaft during the pivotal movement.

Surprisingly, it has been found that the best braking action at very high rotational speed can be achieved by providing means for canting the processing tool unit against the central shaft to provoke a jamming, instead of relying on friction over a large surface and due to materials with a high coefficient of friction, as known for lesser rotational speed. As soon as the pivotal movement of the processing tool device with respect to the central shaft begins, e.g. due to removal of the lid, the bearing part of the processing tool device cants against the central shaft, thus leading to an immediate jamming. Thanks to this kind of braking, the processing tool unit stops within 1.5 seconds after the beginning of the pivotal movement—even at high speeds of 12000-15000 rps.

In preferred embodiments of the present invention, the bearing part comprises a two edge contact zone, both its edges being in contact with the central shaft during the pivotal movement. It has been found out that a jamming during pivotal movement can be very efficiently provoked by providing two edges at the bearing part, both edges canting against the central shaft. The arrangement of the two edges can be chosen depending on the length of the central shaft and the elongated cavity as well as the pivoting angle. A very preferred arrangement is to have two concentric edges running around the central shaft to get a jamming in every canting position.

Advantageously, the two edge contact zone is cylindrical. The upper and the lower edge of the cylinder are the edges for jamming during pivoting movement. During regular rotation of the processing tool unit, i.e. during processing operation, the cylindrical two edge contact zone acts as bearing for the central shaft. During regular operation, the processing tool unit is centered by coupling means, which are part of the lid or reach through the lid, and couple the processing tool unit with a drive unit. Due to the processing tool unit being centered, there is no canting and a smooth rotation is even enhanced by the bearing provided by the cylindrical part between the two edges.

Preferably, the two edge contact zone is located in the lower half of the elongated cavity. This allows for a larger pivoting angle as well as for a faster and more efficient canting and jamming, thus for a faster stopping of the processing tool unit. In case of a cylindrical two edge contact zone, the stability during regular rotation is further improved.

Advantageously, the bearing part has a tapered shape on its inner surface in direction to the two edge contact zone, as a smooth inner surface can be more easily cleaned.

In preferred embodiments of the present invention, the cavity further contains a part made of an elastic material to attenuate the noise during canting and jamming.

The central shaft and the cavity are preferably dimensioned such that at least one third of the processing tool unit encompasses the central shaft to increase the stability during regular rotation and to better avoid a random ejection of the processing tool unit during the pivotal movement.

The tool for processing food is advantageously arranged on the lower end of the processing tool unit. This lowers the center of gravity of the processing tool unit and enhances stability during rotation and helps avoiding a random ejection of the processing tool unit during the pivotal movement.

In preferred embodiments of the present invention, the tool for processing food is a chopping blade. Other possible tools are e.g. disks for grating or rasping.

The best results have been achieved by using a central shaft made of metal and a bearing part made of plastic material, i.e. a pair of materials having a low coefficient of friction when coming into contact.

A detailed description of the invention is provided below. Said description is provided by way of a non-limiting example to be read with reference to the attached drawings in which:

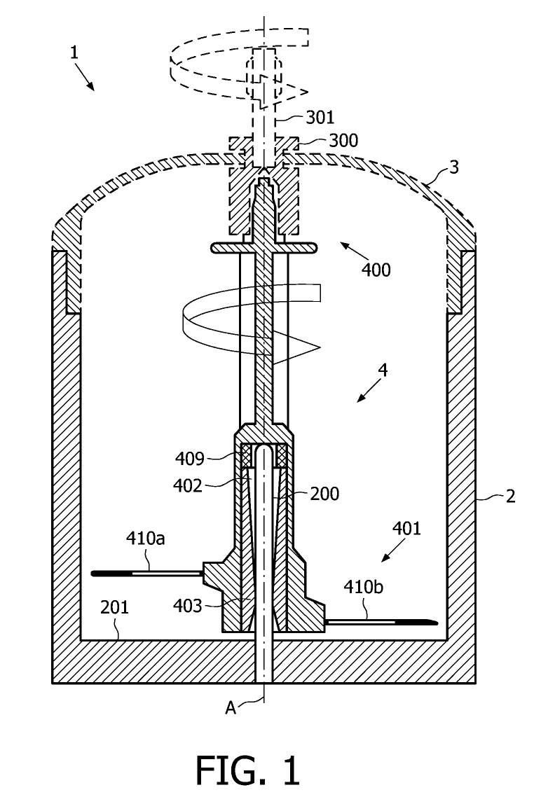

FIG. 1 shows a cut through a food processing device according to the present invention with the lid covering the container;

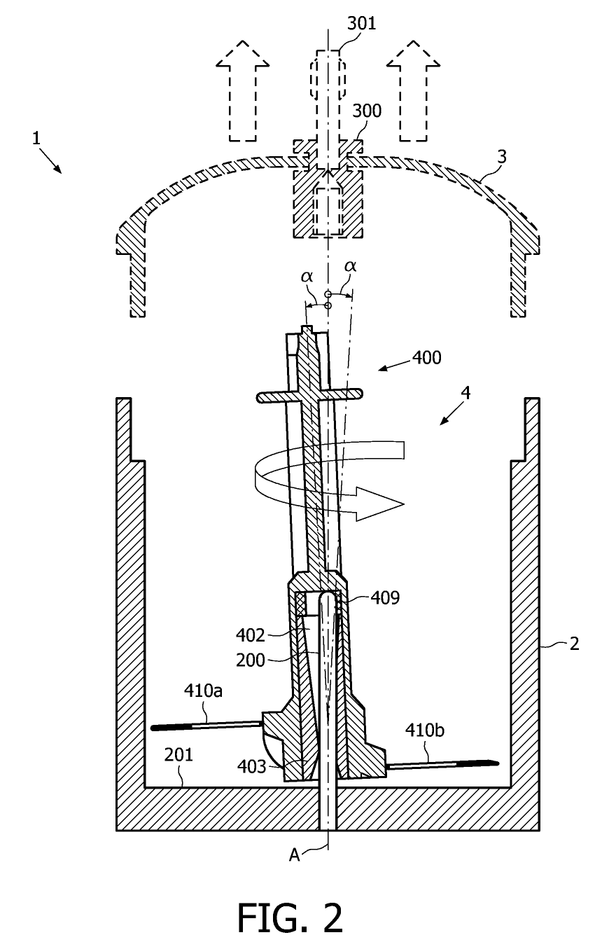

FIG. 2 shows a cut through the food processing device of FIG. 1 with removed lid;

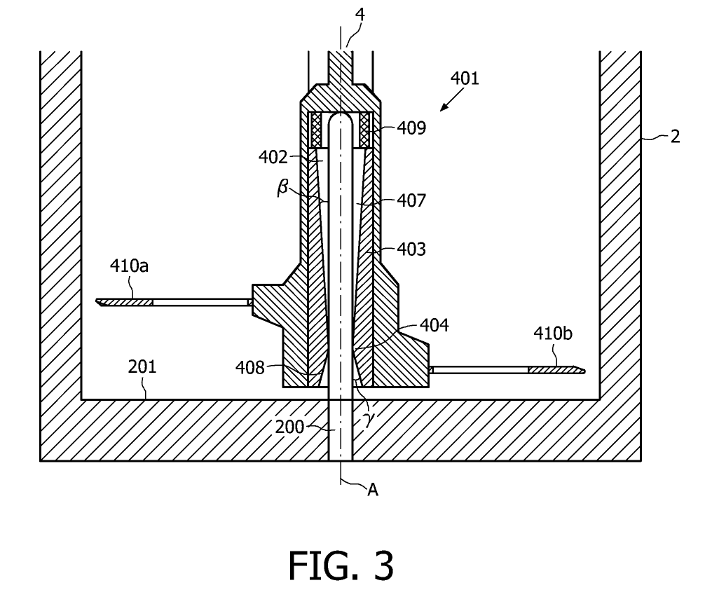

FIG. 3 shows as enlarged detail the lower part of the food processing device of FIG. 1; and

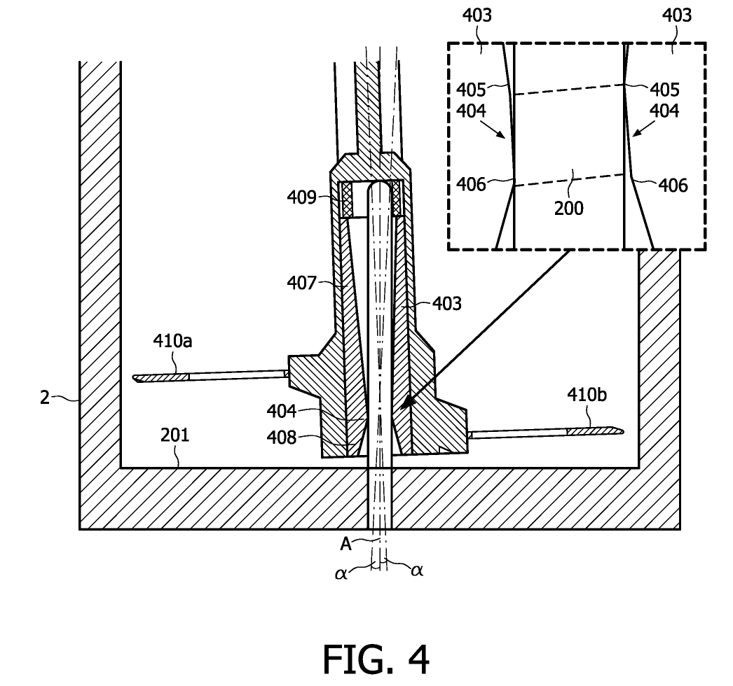

FIG. 4 shows as enlarged detail the lower part of the food processing device of FIG. 2.

The invention will be explained further in detail with reference to a chopper 1 as illustrated in FIG. 1.

The chopper 1 includes a container 2 to accommodate the food to be chopped, e.g. nuts, herbs, vegetables etc. During operation, the container 2 is covered by a lid 3 to avoid food to be ejected form the container 2. In the middle of the bottom wall 201 of the container 2, a central shaft 200 made of steel is provided, over which a processing tool unit 4 is slipped.

At its lower end 401, the processing tool unit 4 has chopping blades 410a,b. The upper end 400 is designed to be coupled to some drive unit (not shown). The drive unit may be a dedicated drive unit or a drive unit that can be used with other food processing device, too. In the present example, the coupling is achieved with help of two coupling elements 300, 301. The coupling element 300 is inserted in the lid 3 and accommodates coupling element 301 to the drive unit. The upper end 400 of the processing tool unit 4 is inserted in coupling element 300. While the upper end 400 of the processing tool unit 4 is inserted in coupling element 300, the processing tool unit 4 is centered with axis A and standing upright, thus allowing for high speed rotation around axis A up to 15000 rpm for chopping.

The lower part 401 of the processing tool unit 4 has an elongated cavity 402 for inserting the central shaft 200. The dimensions of the cavity 402 and the central shaft 200 are such that 40% of the total length of the processing tool unit 4 encompasses the central shaft 200 to improve stability during rotation and avoid having the processing tool unit 4 ejected and damaging other parts of the chopper 1 during pivotal movement.

Stability during rotation is further improved by having the chopping blades 410a,b arranged at the lower end 401 of the processing tool unit 4, thus moving the center of gravity of the processing tool unit 4 to the region encompassing the central shaft 200. Besides, the food is processed more efficiently, if the chopping blades 410a,b are near to the container bottom 201, especially it there are only small amounts of food. It will be noted that in case of a food processing device using e.g. a disk for rasping, cutting or grating, the disk would be located such that there is enough place under the disk for the processed food. Eventually, the central shaft 200 and the elongated cavity 402 would be even longer.

The elongated cavity 402 comprises a bearing part 402 made of hard plastic material admitted for use with food such as ABS (Acrylonitrile Butadiene Styrene) to provide a low coefficient of friction with the steel central shaft 200. The bearing part 403 has a predetermined shape on its inner surface for jamming with the central shaft during the pivotal movement. This is shown more in detail in FIG. 3.

The bearing part 403 of the present example has three zones 404, 407, 408. The actual function of bearing the central shaft 200 is fulfilled by the cylindrical two edge contact zone 404. This zone 404 is arranged in the lower third of the bearing part 403 to increase stability during rotation and allow a pivotal movement. Adjacent to the cylindrical two edge contact zone 404 are a lower tapered zone 408 with a tapering angle γ and an upper tapered zone 407 with a tapering angle β. This leads to a smooth inner surface of the bearing part 403 being easier to clean and improving the stability of the bearing part 403 itself. The lower tapered zone 408 helps to slip the processing tool unit 4 over the central shaft 200.

If the lid 3 is removed from the container 2, as illustrated in FIG. 2, not only is the processing tool unit 4 not driven to rotation any more, but also is a pivotal movement with pivoting angle α around axis A possible, as is shown more in detail in FIG. 4. Due to inertia, the processing tool unit 4 continues to rotate with very high speed and simultaneously pivots with pivoting angle α. The pivoting angle α is defined by the inner diameter of a rubber ring 409 located over the bearing part 403, and the position and height of the cylindrical two edge contact zone 404. The height of the cylindrical two edge contact zone 404 is chosen such that on the one hand, it has a bearing function for the centrals shaft 200 during rotation, and on the other hand, it does still allow a pivotal movement, as soon the lid 3 with the centering coupling element 300 is removed.

It will be noted that the tapering angles β, γ are larger than the pivoting angle α to not influence the pivotal movement except by the two edges 405, 406 (see insert in FIG. 4): Due to the pivotal movement, the bearing part 403 cants against the central shaft 200. The central shaft 200 then gets kind of clamped between the upper edge 405 on the one side and the lower edge 406 on the other side. This leads to a jamming and a stopping of the processing tool unit 4 within 1.5 seconds even if the rotational speed was as high as 12000-15000 rpm. The time the user has removed the lid and put it aside, the processing tool unit 4 stands still and can be removed for cleaning and for emptying the container 2, without danger of being injured or of the processing tool unit 4 being ejected and damaging other parts of the chopper.

During the pivotal movement, the upper end of the central shaft 200 hitting against the inner wall of the elongated cavity 402 may cause annoying noise. To dampen this noise, the rubber ring 409 is provided inside the elongated cavity 402 above the bearing part 403. Instead of rubber, any other elastic material may be utilized.

Although having described several preferred embodiments of the invention, those skilled in the art would appreciate that various changes, alterations, and substitutions can be made without departing from the spirit and concepts of the present invention. The invention is, therefore, claimed in any of its forms or modifications with the proper scope of the appended claims. For example various combinations of the features of the following dependent claims could be made with the features of the independent claim without departing from the scope of the present invention. Furthermore, any reference numerals in the claims shall not be construed as limiting scope.

### LIST OF REFERENCE NUMERALS

1 chopper

2 container

3 lid

4 processing tool unit

200 central shaft

201 container bottom

300 lid coupling element

301 drive unit coupling element

400 upper end

401 lower end

402 elongated cavity

403 bearing part

404 two edge contact zone

405 upper edge

406 lower edge

407 upper tapered zone

408 lower tapered zone

409 rubber part

410a,b chopping blade

A central axis

α pivoting angle

β upper tapering angle

γ lower tapering angle

1. A food processing device comprising:
a container comprising a central shaft fixedly mounted on the container bottom;
a lid covering the container (2);
a processing tool unit supporting a food processing tool, its upper end (400) being couplable with a drive unit through the lid, its lower end having an elongated cavity for rotatably engaging with the central shaft and allowing for pivotal movement about the axis (A) of the central shaft (200), the elongated cavity being provided with a bearing part characterized in that,
the bearing part has a predetermined shape on its inner surface for jamming with the central shaft during the pivotal movement.

2. The food processing device according to claim 1, characterized in that the bearing part comprises a two edge contact zone, both its edges being in contact with the central shaft during the pivotal movement.

3. The food processing device according to claim 2, characterized in that the two edge contact zone is cylindrical.

4. The food processing device according to claim 2 or 3, characterized in that the two edge contact zone is located in the lower half of the elongated cavity.

5. The food processing device according to any of claims 2 to 4, characterized in that the bearing part has a tapered shape on its inner surface in direction to the two edge contact zone.

6. The food processor device according to claim 1, characterized in that the cavity further contains a rubber part.

7. The food processor device according to claim 1, characterized in that the central shaft and the cavity are dimensioned such that one third of the processing tool unit encompasses the central shaft.

8. The food processor device according to claim 1, characterized in that the tool for processing food is arranged on the lower end of the processing tool unit.

9. The food processor device according to claim 1, characterized in that the tool for processing food is a chopping blade.

10. The food processor device according to claim 1, characterized in that the central shaft is made of metal and the bearing part is made of plastic material.
